(19) United States
(12) Patent Application Publication
(10) Pub. No.: US 2025/0377584 A1
(43) Pub. Date: Dec. 11, 2025

(54) LIGHT SOURCE DEVICE AND PROJECTOR

(71) Applicant: SEIKO EPSON CORPORATION, Tokyo (JP)

(72) Inventor: Tomoharu MASUDA, MATSUMOTO-SHI (JP)

(21) Appl. No.: 19/229,117

(22) Filed: Jun. 5, 2025

(30) Foreign Application Priority Data
Jun. 6, 2024 (JP) 2024-092180

(51) Int. Cl. G03B 21/20; G03B 21/14

(52) U.S. Cl. CPC G03B 21/204; G03B 21/145; G03B 21/2013

(57) ABSTRACT

A light source device according to the present disclosure includes a light source section including a light-emitting element that emits light from a light-emitting surface, a substrate that supports the light-emitting element, and, at a light-emitting surface side of the light-emitting element, a metal wire that electrically connects the light-emitting element and the substrate, a light guide member into which the light emitted from the light-emitting element enters and from which the light is emitted; and a support member that supports the light guide member and that has conductivity, wherein the support member includes a support groove for accommodating the light guide member, the support groove includes a support surface that supports the light guide member and a side wall surface of a side wall section that intersects with the support surface and that faces a side surface of the light guide member, the light source section faces a top surface of the side wall section, and an insulating section is provided on at least one of the top surface and the side wall surface.

The present application is based on, and claims priority from JP Application Serial Number 2024-092180, filed Jun. 6, 2024, the disclosure of which is hereby incorporated by reference herein in its entirety.

### BACKGROUND

### 1. Technical Field

This disclosure relates to a light source device and a projector.

### 2. Related Art

As a light source device used for a projector, there has been proposed a light source device that includes a phosphor rod and a light source section with a substrate and a light-emitting element mounted on the substrate, and that utilizes phosphorescence emitted by the phosphor rod by causing excitation light emitted by the light-emitting element to be incident on the phosphor rod.

JP-A-2021-190581 describes a light-emitting device in which wires are insulated by a sealing resin that covers a plurality of light-emitting elements (LED dies) mounted on the surface of a substrate and a plurality of wires connecting the light-emitting elements to the substrate.

However, when the above-described light-emitting device is used as the light source section of a light source device, it is necessary to dispose the light-emitting element at a position away from the phosphor rod by at least a distance corresponding to the thickness of the sealing resin.

Therefore, since it is difficult to dispose the light-emitting element close to the phosphor, it is challenging to reduce the amount of excitation light that is not incident on the phosphor rod among the excitation light emitted from the light-emitting element. Therefore, there is a possibility that the utilization efficiency of the excitation light emitted from the light-emitting element is lowered.

### SUMMARY

In order to solve the above problem, a light source device according to an aspect of the present disclosure includes a light source section including a light-emitting element that emits light from a light-emitting surface, a substrate that supports the light-emitting element, and, at a light-emitting surface side of the light-emitting element, a metal wire that electrically connects the light-emitting element and the substrate, a light guide member into which the light emitted from the light-emitting element enters and from which the light is emitted; and a support member that supports the light guide member and that has conductivity, wherein the support member includes a support groove for accommodating the light guide member, the support groove includes a support surface that supports the light guide member and a side wall surface of a side wall section that intersects with the support surface and that faces a side surface of the light guide member, the light source section faces a top surface of the side wall section, and an insulating section is provided on at least one of the top surface and the side wall surface.

A projector including one aspect of the present disclosure a light source device according to one aspect of the present disclosure, a light modulation device that modulates the light emitted from the light source device; and a projection optical device that projects the light modulated by the light modulation device.

### BRIEF DESCRIPTION OF THE DRAWINGS

FIG. 1 is a schematic configuration diagram of a projector of an embodiment.

FIG. 2 is a schematic configuration diagram of the first lighting device.

FIG. 3 is a plan view showing a schematic configuration of the light source section.

FIG. 4 is a cross-sectional view of the light source device taken along line IV-IV of FIG. 2.

FIG. 5 is a cross-sectional view of the light source device of the second embodiment.

FIG. 6 is a cross-sectional view of the light source device of the third embodiment.

FIG. 7 is a cross-sectional view of the light source device of the fourth embodiment.

### DESCRIPTION OF EMBODIMENTS

Hereinafter, embodiments of the present disclosure will be described. The projector according to the present embodiment is an example of a projector using a liquid crystal panel as a light modulation device. In each of the following drawings, the dimensions of the components may be shown on different scales in order to make the components easier to see.

Hereinafter, in the drawings, the XYZ orthogonal coordinate system will be used as necessary for description. The X-axis is an axis extending in a direction in which the light guide member of the embodiment described below. In the following description, a direction in which the X-axis extends (X-axis direction) may be referred to as a “longitudinal direction”. The Z-axis is an axis along the vertical direction of the projector. In the following description, a direction in which the Z-axis extends is referred to as a Z-axis direction. The Y-axis is an axis orthogonal to both the X-axis and the Z-axis. In the following description, a direction in which the Y axis extends (Y-axis direction) may be referred to as an “incident direction”. The incident direction is the direction in which the first light enters the light guide member. The incident direction is the direction in which the light source section emits the first light, that is, light. In the following description, a side on which an arrow of the X-axis is directed is referred to as a +X side, an opposite side thereof is referred to as a −X side, a side on which an arrow of the Y-axis is directed is referred to as a +Y side, an opposite side thereof is referred to as a −Y side, a side on which an arrow of the Z-axis is directed is referred to as a +Z side, and an opposite side thereof is referred to as a −Z side.

### First Embodiment

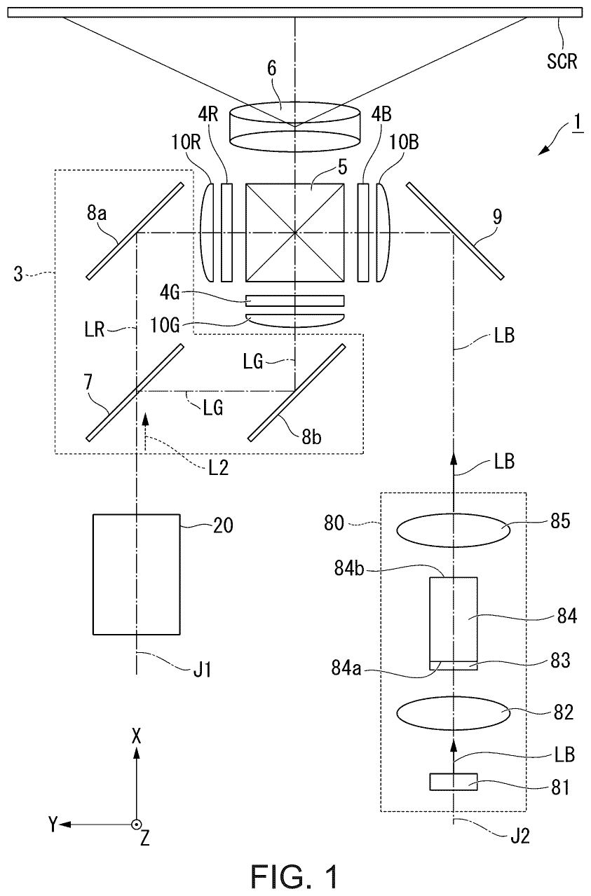

FIG. 1 is a schematic configuration diagram of projector 1 of the present embodiment. As shown in FIG. 1, projector 1 is a projection-type image display device that displays a color image on a screen SCR as a projection surface. The projector 1 includes three light modulation devices 4R, 4G, and 4B corresponding to the color lights of red light LR, green light LG, and blue light LB, respectively. The projector 1 includes a first lighting device 20, a second lighting device 80, a color separation optical system 3, light modulation devices 4R, 4G, and 4B, a light combining element 5, and a projection optical device 6.

The first lighting device 20 emits yellow second light L2 toward the color separation optical system 3. The second light L2 is light emitted from the light source device 21 included in the first lighting device 20. The second lighting device 80 emits the blue light LB toward the light modulation device 4B. The detailed configurations of the first lighting device 20 and the second lighting device 80 will be described later.

The first optical axis J1 appropriately shown in each of the drawings is the center axis of the second light L2 emitted from the first lighting device 20. The second optical axis J2 shown in FIG. 1 is the central axis of the blue light LB emitted from the second lighting device 80. The first optical axis J1 and the second optical axis J2 extend in a direction parallel to the longitudinal direction (X-axis direction).

The color separation optical system 3 separates the yellow second light L2 emitted from the first lighting device 20 into red light LR and green light LG. The color separation optical system 3 includes a dichroic mirror 7, a first reflecting mirror 8a, and a second reflecting mirror 8b.

The dichroic mirror 7 separates the second light L2 into red light LR and green light LG. The dichroic mirror 7 transmits the red light LR and reflects the green light LG. The second reflecting mirror 8b is disposed in the optical path of the green light LG. The second reflecting mirror 8b reflects the green light LG reflected by the dichroic mirror 7 toward the light modulation device 4G. The first reflecting mirror 8a is disposed in the optical path of the red light LR. The first reflecting mirror 8a reflects the red light LR transmitted through the dichroic mirror 7 toward the light modulation device 4R.

The blue light LB emitted from the second lighting device 80 is reflected toward the light modulation device 4B by the reflecting mirror 9. The second lighting device 80 includes a second light source section 81, a condenser lens 82, a diffusion plate 83, a rod lens 84, and a relay lens 85. The second light source section 81 is configured from at least one semiconductor laser. The second light source section 81 emits blue light LB, which is formed of laser light, towards the condenser lens 82.

It should be noted that the second light source section 81 is not limited to a semiconductor laser, and may be configured by an LED that emits blue light.

The condenser lens 82 is configured from a convex lens. The condenser lens 82 causes the blue light LB emitted from the second light source section 81 to be incident on the diffusion plate 83 in a condensed state. The diffusion plate 83 generates blue light LB with a uniform light distribution by diffusing the blue light LB emitted from the condenser lens 82 to a predetermined degree of diffusion. The diffusion plate 83 is, for example, composed of frosted glass made from optical glass.

The blue light LB diffused by the diffusion plate 83 is incident on the rod lens 84. The rod lens 84 includes a prismatic shape extending along the second optical axis J2 direction. The rod lens 84 includes a light input end surface 84a provided at one end and a light output end surface 84b provided at the other end. The diffusion plate 83 is fixed to the light input end surface 84a of the rod lens 84 via an optical adhesive (not shown). The refractive index of the diffusion plate 83 and the refractive index of the rod lens 84 should be matched as closely as possible.

The blue light LB propagates through the inside of the rod lens 84 while being totally reflected, and thus is emitted from the light output end surface 84b in a state where the uniformity of the illuminance distribution is enhanced. The blue light LB emitted from rod lens 84 is incident on the relay lens 85. The relay lens 85 causes the blue light LB, whose uniformity of illuminance distribution has been enhanced by the rod lens 84, to enter reflecting mirror 9. The shape of the light output end surface 84b of the rod lens 84 is a rectangular shape substantially similar to the shape of the image forming region of the light modulation device 4B. Thus, the blue light LB emitted from the rod lens 84 is efficiently incident on the image forming area of the light modulation device 4B.

The light modulation device 4R modulates the red light LR in accordance with image information to form image light corresponding to the red light LR. The light modulation device 4G modulates the green light LG in accordance with image information to form image light corresponding to the green light LG. The light modulation device 4B modulates the blue light LB in accordance with image information to form image light corresponding to the blue light LB. Each light modulation device 4R, 4G, and 4B can be, for example, a transmissive liquid crystal panel. Polarizing plates (not shown) are disposed on the incident side and the emitting side of each of the light modulation devices 4R, 4G, and 4B. The polarizing plates transmit only light linearly polarized in a specific direction. As described above, the red light LR and the green light LG is light obtained by separating the second light L2 by the dichroic mirror 7. Therefore, the light modulation devices 4R and 4G modulate the second light L2, that is, the light emitted from the light source device 21.

A field lens 10R is disposed on the incident side of the light modulation device 4R. The field lens 10R collimates the principal rays of the red light LR incident on the light modulation device 4R. A field lens 10G is disposed on the incident side of the light modulation device 4G. The field lens 10G collimates the principal rays of the green light LG incident on the light modulation device 4G. A field lens 10B is disposed on the incident side of the light modulation device 4B. The field lens 10B collimates the principal rays of the blue light LB incident on the light modulation device 4B.

The light combining element 5 combines the image light modulated by each of the light modulation devices 4R, 4G, and 4B, and emits the combined image light toward the projection optical device 6. As the light combining element 5, for example, a cross dichroic prism can be used.

The projection optical device 6 is composed of a plurality of projection lenses (not shown). The projection optical device 6 enlarges and projects the image light combined by the light combining element 5 toward the screen SCR. The projection optical device 6 projects the light modulated by the light modulation devices 4R, 4G, and 4B toward the screen SCR. Thus, a color image is displayed on the screen SCR.

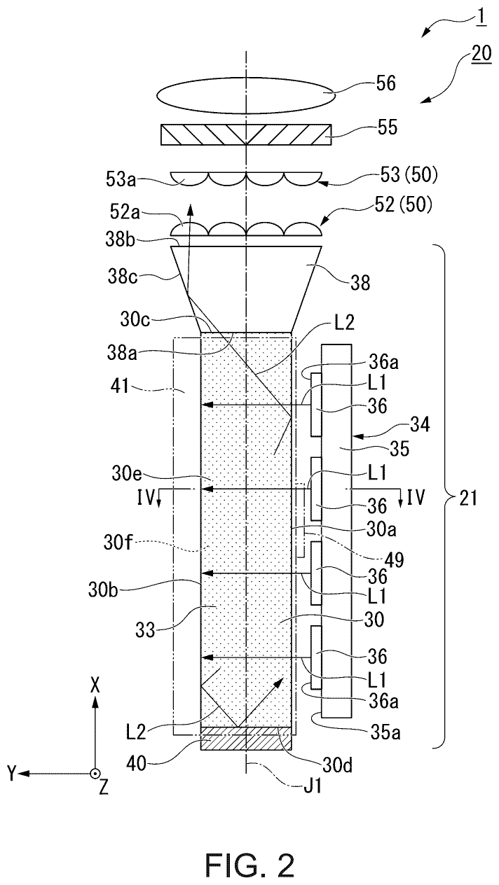

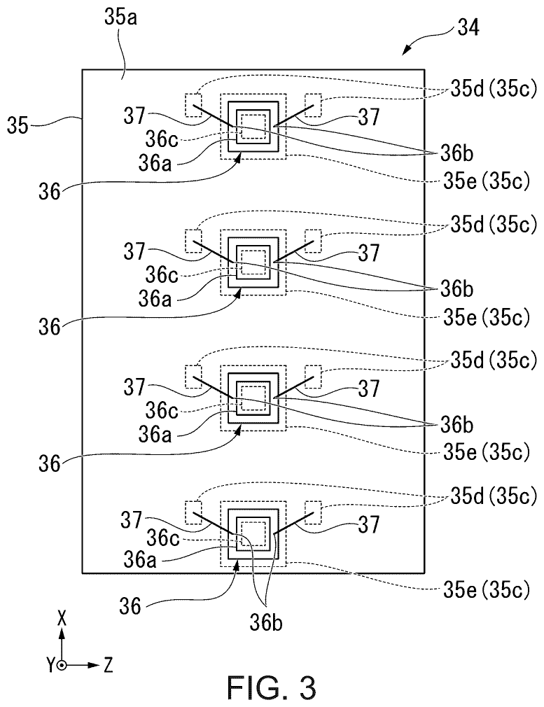

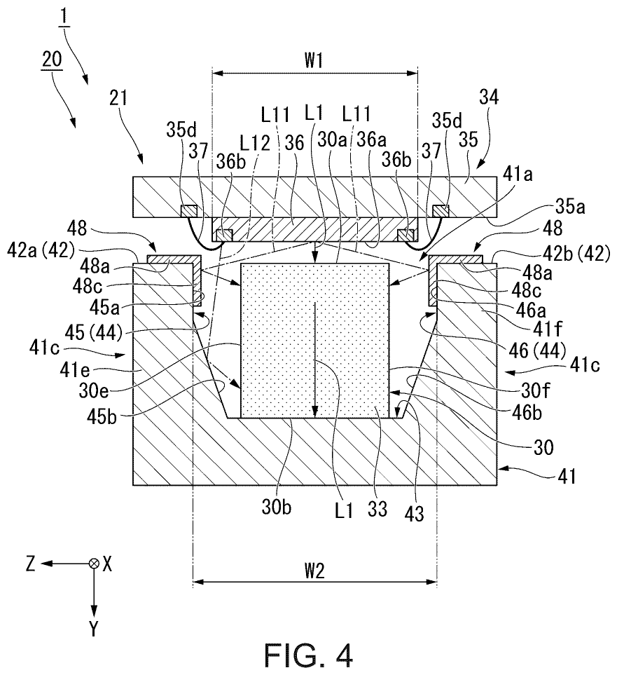

FIG. 2 is a schematic configuration diagram of the first lighting device 20. FIG. 3 is a plan view showing a schematic configuration of a light source section 34. FIG. 4 is a cross-sectional view of a light source device 21 taken along line IV-IV in FIG. 2. As shown in FIG. 2, the first lighting device 20 includes the light source device 21, an integrator optical system 50, a polarization conversion element 55, and a superimposition optical system 56.

The light source device 21 converts first light L1 into the yellow second light L2 and emits the second light L2 toward the integrator optical system 50. The light source device 21 includes a wavelength conversion member 30, a light source section 34, an angle conversion member 38, a mirror 40, a support member 41, and a pressing member 49. The wavelength conversion member 30 of the present embodiment corresponds to a “light guide member” in the claims. Therefore, the light source device 21 includes a light guiding member.

The wavelength conversion member 30 has a quadrangular prism shape extending along the longitudinal direction (X-axis direction) and has six surfaces. The dimension of the wavelength conversion member 30 in the longitudinal direction is larger than the dimension in the incident direction (Y-axis direction) and than the dimension in the Z-axis direction. The dimension in the incident direction and the dimension in the Z-axis direction of the wavelength conversion member 30 are substantially the same. Therefore, the cross-sectional shape of the wavelength conversion member 30, when cut along a plane perpendicular to the longitudinal direction, is substantially square. The cross-sectional shape of the wavelength conversion member 30, when cut along a plane perpendicular to the longitudinal direction, may be another shape such as a rectangle.

The wavelength conversion member 30 has a first surface 30a and a second surface 30b that are orthogonal to the incident direction (the Y-axis direction) and are located on opposite sides of the incident direction. The second surface 30b is located on the +Y side of the first surface 30a. The first surface 30a and the second surface 30b face away from each other. The wavelength conversion member 30 has a third surface 30c and a fourth surface 30d that are orthogonal to the longitudinal direction (X-axis direction) and that are located on opposite sides of the longitudinal direction. The fourth surface 30d is located on the −X side of the third surface 30c. The third surface 30c and the fourth surface 30d face away from each other. As shown in FIG. 4, the wavelength conversion member 30 has a fifth surface 30e and a sixth surface 30f that are orthogonal to the Z-axis direction and are located on opposite sides in the Z-axis direction. The sixth surface 30f is located on the −Z side of the fifth surface 30e. The fifth surface 30e and the sixth surface 30f face away from each other. In the present embodiment, the fifth surface 30e and the sixth surface 30f are side surfaces of the wavelength conversion member 30. That is, the fifth surface 30e and the sixth surface 30f are side surfaces of the light guide member. In the following description, the fifth surface 30e may be referred to as one side surface of the wavelength conversion member 30, and the sixth surface 30f may be referred to as the other side surface of the wavelength conversion member 30.

The wavelength conversion member 30 does not necessarily have to have a quadrangular prism shape and may have other shapes such as a triangular prism or a cylindrical shape. When the shape of the wavelength conversion member 30 is a triangular prism, the three surfaces that intersect with the emission end surface 30c and the reflection end surface 30d are collectively defined as a side surface. When the shape of the wavelength conversion member 30 is cylindrical shape, one continuous curved surface that intersects both the emission end face 30c and the reflection end face 30d is defined as a side surface

As shown in FIG. 2, the wavelength conversion member 30 includes at least a phosphor 33 and converts first light L1 having a first wavelength band emitted from the light source section 34 into second light L2 having a second wavelength band different from the first waveband. The wavelength conversion member 30 emits the second light L2 toward the angle conversion member 38. The first light L1 is emitted from the light source section 34 in the incident direction (Y-axis direction) and is incident on the wavelength conversion member 30 from the first surface 30a. The second light L2 is guided inside the wavelength conversion member 30, and then emitted from the third surface 30c toward the angle conversion member 38.

In the present embodiment, the phosphor 33 is a ceramic phosphor made of a multicrystal phosphor that converts first light L1 into second light L2. The second wavelength band of the second light L2 is, for example, a yellow wavelength band of 490 to 750 nm. That is, the second light L2 is yellow fluorescence containing a red light component and a green light component. The phosphor 33 may be a single crystal phosphor. The wavelength conversion member 30 may be made of fluorescent glass. The wavelength conversion member 30 may be composed of a material in which a large number of phosphor particles are dispersed in a binder made of glass or resin.

In this embodiment, the wavelength conversion member 30 includes, for example, a yttrium-aluminum-garnet (YAG)-based phosphor. Using YAG: Ce, which contains cerium (Ce) as an activator agent, as an example, the material for the wavelength conversion member 30 may be a material obtained by mixing a starting material powder containing constituent elements such as Y₂O₃, Al₂O₃, CeO₃ and causing a solid-phase reaction, may be Y—Al—O amorphous particles obtained by a wet method such as a coprecipitation method or a sol-gel method, or may be YAG particles obtained by a gas phase method such as a spray drying method, a flame pyrolysis method, or a thermal plasma method.

When the first light L1 is incident on the wavelength conversion member 30, the phosphor 33 absorbs the first light L1 and emits second light L2 having a second wavelength band. Thus, the wavelength conversion member 30 converts the first light L1 into the second light L2.

The light source section 34 irradiates the first light L1 to the wavelength conversion member 30. The light source section 34 is disposed to face the first surface 30a of the wavelength conversion member 30 in the incident direction (Y-axis direction). As shown in FIG. 4, the light source section 34 includes a substrate 35, a light-emitting element 36, and a metal wire 37. The light source section 34 may have other optical members such as a light guide plate, a diffusion plate, and a lens.

The substrate 35 is a plate-like shape extending in a direction perpendicular to the incident direction (Y-axis direction). As shown in FIG. 3, when viewed from the incident direction, the substrate 35 has a substantially rectangular shape with the long side extending in the longitudinal direction (X-axis direction). As shown in FIG. 4, the substrate 35 includes a surface 35a. The surface 35a is a surface of the substrate 35 that faces the +Y direction among the outer surfaces. The surface 35a faces the wavelength conversion member 30 in the incident direction.

The light-emitting element 36 is mounted on the surface 35a of the substrate 35. Thus, the substrate 35 supports the light-emitting element 36. The light-emitting element 36 is composed of, for example, a light-emitting diode (LED). The light-emitting element 36 includes a light-emitting surface 36a. The light-emitting surface 36a faces the first surface 30a of the wavelength conversion member 30 in the incident direction (Y-axis direction). The light-emitting element 36 emits the first light L1, which has a first wavelength band, that is, light, from the light-emitting surface 36a toward the first surface 30a of the wavelength conversion member 30. Thus, the first light L1 emitted from the light-emitting element 36 is incident on the wavelength conversion member 30. The wavelength conversion member 30 converts the first light L1 into the second light L2 and emits the second light L2. In the present embodiment, the first wavelength band is, for example, a waveband from blue to purple in 400 nm to 480 nm. The peak wavelength of the first light L1 is, for example, 445 nm.

As shown in FIG. 2, the light source section 34 includes a plurality of light-emitting elements 36. In the present embodiment, the light source section 34 includes four light-emitting elements 36. The light-emitting elements 36 are disposed side by side in the longitudinal direction (X-axis direction). Each light-emitting element 36 faces the first surface 30a in the incident direction (Y-axis direction). The number of light-emitting elements 36 included in the light source section 34 is not particularly limited, and may be three or less, or may be five or more.

As shown in FIG. 3, each light-emitting element 36 has two anode electrodes 36b and one cathode electrode 36c. In this embodiment, each anode electrode 36b is provided on the surface facing the +Y side of the light-emitting element 36, and the cathode electrode 36c is provided on the surface facing the −Y side of the light-emitting element 36. In the present embodiment, the two anode electrodes 36b are disposed so as to sandwich the light-emitting surface 36a. This stabilizes the current density supplied to the light-emitting surface 36a, so that the light-emitting surface 36a emits light uniformly. Therefore, each light-emitting element 36 can emit uniform and bright light from the light-emitting surface 36a.

On the surface 35a of the substrate 35, a terminal portion 35c electrically connected to each light-emitting element 36 is provided. The terminal section 35c includes a first conductive section 35d which is electrically connected to the anode electrode 36b of each light-emitting element 36, and a second conductive section 35e which is electrically connected to the cathode electrode 36c of each light-emitting element 36. Each light-emitting element 36 is mounted on the substrate 35 in a state where the cathode electrode 36c is placed on the second conductive section 35e. For example, a solder layer is provided between the cathode electrode 36c and the second conductive section 35e. Although details are omitted, the first conductive section 35d and the second conductive section 35e are configured to connect the light-emitting elements 36 in series. Thus, a current flows sequentially along the longitudinal direction (X-axis direction) for each light-emitting element 36.

The anode electrode 36b of each light-emitting element 36 is connected to the first conductive section 35d via the metal wire 37. As described above, each anode electrode 36b is provided on the surface facing the +Y side of the light-emitting element 36, and the first conductive portion 35d is provided on the surface 35a of the substrate 35. Therefore, as shown in FIG. 4, the metal wire 37 electrically connects the light-emitting element 36 and the substrate 35 on the light-emitting surface 36a side of the light-emitting element 36. In the present embodiment, the metal wire 37 is provided on both the +Z side and the −Z side of the light-emitting element 36. The metal wire 37 is provided by a wire bonding device. The terminal section 35c shown in FIG. 3 is connected to a wiring section (not shown) provided on the substrate 35. Thus, each light-emitting element 36 is electrically connected to an external device through the metal wire 37, the terminal section 35c, and the wiring section, and drive power and the like are supplied thereto.

As shown in FIG. 2, the support member 41 extends in the longitudinal direction (X-axis direction) and supports the wavelength conversion member 30, that is, the light guide member. The heat generated in the wavelength conversion member 30 is transferred to the support member 41, and the heat is radiated to the outside of the light source device 21. Therefore, it is desirable that the support member 41 is made of a material that has a predetermined strength and high thermal conductivity. In the present embodiment, the support member 41 is made of metal. The support member 41 has conductivity. As a material for the support member 41, aluminum, stainless steel, or the like can be used, and it is particularly desirable to use an aluminum alloy such as the 6061 series. In this embodiment, the support member 41 is made of aluminum. As shown in FIG. 4, the support member 41 has a support groove 41a.

The support groove 41a is a groove recessed to the +Y side from the surface of the support member 41 that faces the −Y side. The support groove 41a extends in the longitudinal direction (X-axis direction) and is open on both sides in the longitudinal direction. When viewed from the longitudinal direction, the width W2 of the support groove 41a is wider than the width W1 of the light-emitting element 36. In the present embodiment, the width W1 of the light-emitting element 36 is the dimension of the light-emitting element 36 in the Z-axis direction. The width W2 of the support groove 41a is the maximum dimension of the support groove 41a in the Z-axis direction. The wavelength conversion member 30 is accommodated in the support groove 41a. The support groove 41a has a support surface 43.

The support surface 43 is a surface of the inner surface of the support groove 41a that faces the −Y side. The support surface 43 supports the second surface 30b of the wavelength conversion member 30 in the incident direction (Y-axis direction). Thus, the support surface 43 supports the wavelength conversion member 30. The detailed configuration of the support member 41 will be described later.

The pressing member 49 shown in FIG. 2 presses the wavelength conversion member 30 against the support member 41. More specifically, the pressing member 49 presses the wavelength conversion member 30 against the support surface 43. The pressing member 49 is configured by, for example, an elastic member such as a leaf spring. Although not shown, one end of the pressing member 49 is connected to the support member 41, and the other end of the pressing member 49 is brought into contact with the first surface 30a of the wavelength conversion member 30. The wavelength conversion member 30 is pressed against the support surface 43 by the elastic force of the pressing member 49. Thus, the adhesion between the wavelength conversion member 30 and the support surface 43 can be increased, and thus the thermal resistance between the wavelength conversion member 30 and the support surface 43 can be reduced. Therefore, heat generated in the wavelength conversion member 30 can be suitably transferred to the support member 41. Thus, by increasing the amount of heat radiated from the wavelength conversion member 30 to the outside of the light source device 21 via the support member 41, it is possible to preferably prevent the temperature of the wavelength conversion member 30 from becoming too high. Therefore, an increase in temperature quenching of the second light L2 in the wavelength conversion member 30 can be suppressed, and the wavelength conversion efficiency of the wavelength conversion member 30 can be improved.

The mirror 40 is provided on the fourth surface 30d of the wavelength conversion member 30. The mirror 40 guides the second light L2 inside the wavelength conversion member 30 and reflects the second light L2 that reached the fourth surface 30d. The mirror 40 is formed of a metallic film or a dielectric multilayer film formed on the fourth surface 30d of the wavelength conversion member 30.

The first light L1 emitted from the light-emitting element 36 toward the first surface 30a is incident inside of the wavelength conversion member 30 from the first surface 30a. When the first light L1 enters into the wavelength conversion member 30, the phosphor 33 is excited by the first light L1 and emits the second light L2. The second light L2 proceeds radially from the center of the phosphor 33. The second light L2 that proceeds toward each of the first surface 30a, the second surface 30b, the fifth surface 30e, and the sixth surface 30f of the wavelength conversion member 30 proceeds toward the third surface 30c or the fourth surface 30d while being repeatedly totally reflected by each of the surfaces 30a, 30b, 30e, and 30f. The second light L2 that proceeds toward the fourth surface 30d is reflected by the mirror 40 and proceeds toward the third surface 30c. Thus, all of the second light L2 emitted by the phosphor 33 proceeds toward the third surface 30c, passes through the third surface 30c, and is incident on the angle conversion member 38.

Of the first light L1 incident on the wavelength conversion member 30, the portion of the first light L1 that was not used to excite the phosphor is reflected by a member around the wavelength conversion member 30 including the light source section 34, or by the mirror 40 provided on the fourth surface 30d. Therefore, a part of the first light L1 is confined inside the wavelength conversion member 30 and is reused for wavelength conversion.

The angle conversion member 38 is provided on the emitting side of the third surface 30c of the wavelength conversion member 30. The second light L2 emitted from the third surface 30c is incident on the angle conversion member 38. The angle conversion member 38 is configured from a light-transmitting member such as a tapered rod. The angle conversion member 38 includes an incident surface 38a onto which the second light L2 emitted from the wavelength conversion member 30 is incident, a light exiting surface 38b for emitting the second light L2, and a reflecting side surface 38c for reflecting the second light L2 toward the light exiting surface 38b. The incident surface 38a faces the third surface 30c in the longitudinal direction (X-axis direction).

The angle conversion member 38 has a truncated quadrangular pyramid shape, and the cross-sectional area of the cross section orthogonal to the first optical axis J1 expands along the proceed direction of the second light L2. Therefore, the area of the light exiting surface 38b is larger than that of the incident surface 38a. In the present embodiment, the optical axis of the angle conversion member 38 coincides with the first optical axis J1.

The second light L2 incident on the angle conversion member 38 changes its advancing direction to approach a direction parallel to the first optical axis J1 each time it is totally reflected by the reflecting side surface 38c. Thus, the angle conversion member 38 converts the emission angle distribution of the second light L2 emitted from the wavelength conversion member 30. More specifically, the angle conversion member 38 makes the maximum emission angle of the second light L2 at the light exiting surface 38b smaller than the maximum incidence angle of the second light L2 at the incident surface 38a.

In general, since the etendue of the light defined by the product of the area of the light emission region and the solid angle, which is the maximum emission angle, is preserved, the etendue of the second light L2 is preserved even before and after the transmission through the angle conversion member 38. As described above, the angle conversion member 38 has a configuration in which the area of the light exiting surface 38b is larger than the area of the incident surface 38a. Therefore, from the viewpoint of etendue preservation, the angle conversion member 38 can be smaller than the maximum incident angle of the second light L2 on the incident surface 38a and the maximum exit angle of the second light L2 on the light exiting surface 38b.

The angle conversion member 38 is fixed to the wavelength conversion member 30 through an optical adhesive (not shown) so that the incident surface 38a faces the third surface 30c of the wavelength conversion member 30. That is, the angle conversion member 38 and the wavelength conversion member 30 are in contact with each other via the optical adhesive, and a gap such as an air layer is not provided between the angle conversion member 38 and the wavelength conversion member 30. If an air gap were provided between the angle conversion member 38 and the wavelength conversion member 30, among the second light L2 reaching the incident surface 38a of the angle conversion member 38, the second light L2 incident on the incident surface 38a at an angle greater than or equal to the critical angle is totally reflected by the incident surface 38a and cannot be incident on the angle conversion member 38. On the other hand, as in the present embodiment, when no gap is provided between the angle conversion member 38 and the wavelength conversion member 30, the loss component of the second light L2 that cannot be incident on the angle conversion member 38 due to total reflection can be reduced. From this point of view, it is desirable that the refractive index of the angle conversion member 38 and the refractive index of the wavelength conversion member 30 match each other as much as possible.

The configuration of the angle conversion member 38 is not limited to the present embodiment and may be, for example, a compound parabolic concentrator (CPC). Even when a CPC is used as the angle conversion member 38, the same effect as in the case where the tapered rod is used can be obtained. The light source device 21 may not include the angle conversion member 38.

The integrator optical system 50 includes a first lens array 52 and a second lens array 53. The optical integration system 50, together with the superimposition optical system 56, functions as a uniform illumination optical system that uniformizes the intensity distribution of the second light L2 emitted from the light source device 21 in each of the light modulation devices 4R and 4G, which are the illuminated regions. The second light L2 emitted from the light exiting surface 38b of the angle conversion member 38 is incident on the first lens array 52.

The first lens array 52 includes a plurality of first small lenses 52a. The first small lenses 52a are arranged in a matrix on a plane orthogonal to the first optical axis J1. Each first small lens 52a splits the second light L2 emitted from the angle conversion member 38 into a plurality of partial light fluxes. The shape of each first small lens 52a is a rectangular shape that is substantially similar to the shape of the image forming region of the light modulation devices 4R and 4G. Thus, each of the partial light beams emitted from the first lens array 52 is efficiently incident on the image forming areas of the light modulation devices 4R and 4G.

The second lens array 53 is disposed on the emitting side of the first lens array 52. The second light L2 emitted from the first lens array 52 is incident on the second lens array 53. The second lens array 53 includes a plurality of second small lenses 53a corresponding to the plurality of first small lenses 52a of the first lens array 52. The second small lens 53a are arranged in a matrix on a plane orthogonal to the first optical axis J1. The second lens array 53, together with the superimposition optical system 56, forms an image of the second light L2 emitted from each first small lens 52a of the first lens array 52 in the vicinity of the image forming region of the light modulation devices 4R and 4G.

In the present embodiment, the first small lenses 52a of the first lens array 52 and the second small lenses 53a of the second lens array 53 have the same size, but may have different sizes. In the present embodiment, the first small lens 52a of the first lens array 52 and the second small lens 53a of the second lens array 53 are disposed at positions where their optical axes coincide with each other, but they may also be disposed in a state where they are eccentric to each other.

The polarization conversion element 55 includes a polarizing separation layer (not shown) that transmits one linearly polarized component included in the second light L2 emitted from the light source device 21 and that reflects the other linearly polarized component in a direction perpendicular to the first optical axis J1, a reflective layer (not shown) that reflects the other linearly polarized component reflected by the polarizing separation layer in a direction parallel to the first optical axis J1, and a phase difference plate (not shown) that converts the other linearly polarized component reflected by the reflective layer into the one linearly polarized component. The polarization conversion element 55 converts the polarization direction of the second light L2 emitted from the second lens array 53. More specifically, the polarization conversion element 55 converts each partial light flux of the second light L2 split by the first lens array 52 and emitted from the second lens array 53 into linearly polarized light.

The second light L2 transmitted through the polarization conversion element 55 is incident on the superimposition optical system 56. The superimposition optical system 56 cooperates with the optical integration system 50 and is configured from a uniform illumination optical system that uniformizes the intensity distribution of the second light L2 in each of the light modulation devices 4R and 4G, which are illuminated regions. The superimposition optical system 56 causes the second light L2 to be incident on the color separation optical system 3.

Next, the support member 41 of the present embodiment will be described in detail. As shown in FIG. 4, the support member 41 includes a U-shaped configuration when viewed from the longitudinal direction (X-axis direction). The support member 41 includes the support groove 41a and the side wall section 41c. The support groove 41a is formed by, for example, cutting the support member 41. The support groove 41a includes a side wall surface 44. In the present embodiment, the support groove 41a is configured by the support surface 43 and the side wall surface 44.

The side wall section 41c is a portion of the support member 41 that faces the wavelength conversion member 30 in the Z-axis direction. When viewed from the longitudinal direction (X-axis direction), the side wall section 41c extends in the incident direction (Y-axis direction). The support member 41 includes a plurality of side wall sections 41c. In this embodiment, the support member 41 includes two side wall sections 41c. The side wall sections 41c include the first side wall section 41e and the second side wall section 41f. The side wall section 41c includes a top surface 42.

The first side wall section 41e is a portion of the support member 41 disposed on the +Z side with respect to the support groove 41a. The first side wall section 41e faces the fifth surface 30e of the wavelength conversion member 30 with a space therebetween in the Z direction. That is, the first side wall section 41e faces one side surface 30e of the wavelength conversion member 30. The first side wall section 41e includes a first top surface 42a. The first top surface 42a is a surface facing the −Y side among the outer surfaces of the first side wall portion 41e. The first top surface 42a faces the substrate 35 in the incident direction (Y-axis direction). That is, the first top surface 42a faces the light source section 34.

The second side wall section 41f is a portion of the support member 41 disposed on the −Z side with respect to the support groove 41a. The second side wall section 41f faces the sixth surface 30f of the wavelength conversion member 30 with a space in the Z direction. That is, the second side wall section 41f faces the other side surface 30f of the wavelength conversion member 30. As described above, the first side wall section 41e faces one side surface 30e of the wavelength conversion member 30. Therefore, the side wall section 41c faces the side surfaces 30e and 30f of the wavelength conversion member 30. The second side wall section 41f faces the first side wall section 41e in the Z-axis direction with the wavelength conversion member 30 interposed therebetween. The second side wall section 41f includes a second top surface 42b. The second top surface 42b is a surface facing the −Y side on the outer surface of the second side wall section 41f. The second top surface 42b faces the substrate 35 in the incident direction (Y-axis direction). That is, the second top surface 42b faces the light source section 34.

In the present embodiment, the top surface 42 is configured by a first top surface 42a and a second top surface 42b. As described above, each of the first top surface 42a and the second top surface 42b faces the light source section 34. Therefore, the light source section 34 faces the top surface 42 of the side wall section 41c.

The side wall surface 44 is a surface of the inner surface of the support groove 41a that faces the wavelength conversion member 30 in the Z-axis direction. In the present embodiment, the support groove 41a includes two side wall surfaces 44. The two side wall surfaces 44 include the first side wall surface 45 and the second side wall surface 46.

The first side wall surface 45 is a surface facing the −Z side in the outer surface of the first side wall section 41e. The first side wall surface 45 intersects the support surface 43. The first side wall surface 45 faces one side surface 30e of the wavelength conversion member 30. The first side wall surface 45 has a first portion 45a located on the side farther from the support surface 43, and a second portion 45b located on the side closer to the support surface 43. The first portion 45a is a part of the first side wall surface 45 on the side of the light source section 34. The first portion 45a extends in a direction perpendicular with respect to the support surface 43. The second portion 45b extends in a direction inclined with respect to the support surface 43. The second portion 45b is an inclined surface that approaches the wavelength conversion member 30 as it approaches the support surface 43.

The second side wall surface 46 is a surface facing the +Z side among the outer surfaces of the second side wall section 41f. The second side wall surface 46 faces the first side wall surface 45 in the Z-axis direction with the wavelength conversion member 30 interposed therebetween. The second side wall surface 46 intersects the support surface 43. As described above, the first side wall surface 45 intersects the support surface 43. Thus, the side wall surface 44 intersects the support surface 43. The second side wall surface 46 faces the other side surface 30f of the wavelength conversion member 30. As described above, the first side wall surface 45 faces one side surface 30e of the wavelength conversion member 30. Therefore, the side wall surface 44 faces the side surfaces 30e and 30f of the wavelength conversion member 30. The second side wall surface 46 has a third portion 46a located on the side farther from the support surface 43, and a fourth portion 46b located on the side closer to the support surface 43. The third portion 46a is a portion of the second side wall surface 46 on the side of the light source section 34. The third portion 46a extends in a direction perpendicular with respect to the support surface 43. The fourth portion 46b extends in a direction inclined with respect to the support surface 43. The fourth portion 46b is an inclined surface that approaches the wavelength conversion member 30 as it approaches the support surface 43.

The support member 41 is provided with an insulating section 48. The insulating section 48 has an insulating property. The insulating section 48 suppresses direct contact between the metal wire 37 and the support member 41. Thus, the insulating section 48 suppresses the metal wire 37 and the support member 41 from being short-circuited. In the present embodiment, the insulating section 48 is formed in a film shape on the surface of the support member 41. As a material composed of the insulating section 48, for example, glass (silicon dioxide), ceramics such as aluminum n oxide, a resin such as polyimide, a dielectric multilayer film, or the like can be used.

When the insulating section 48 is made of glass, the insulating section 48 can be formed by a physical vapor deposition method such as vacuum deposition. When the insulating section 48 is made of glass, the heat resistance of the insulating section 48 can be increased.

when the insulating section 48 is made of aluminum oxide, the insulating section 48 can be formed by a physical vapor deposition method such as sputtering or a manufacturing method such as subjecting the support member 41 to alumite treatment. When the insulating section 48 is made of aluminum oxide, the heat resistance of the insulating section 48 can be increased.

When the insulating section 48 is made of a resin, the insulating section 48 can be formed by a simple process of the curing the resin applied to the surface of the support member 41. Therefore, it is possible to suppress an increase in the man-hours and the cost of forming the insulating section 48 on the support member 41. When the insulating section 48 is made of polyimide, the light resistance of the insulating section 48 can be increased, so that deterioration of the insulating section 48 can be suppressed.

When the insulating section 48 is made of a dielectric multilayer film, materials made of a low refractive index layer may include silicon dioxide and magnesium fluoride, or the like, and materials made of a high refractive index layer may include zirconium dioxide and tantalum pentoxide, or the like. When the insulating section 48 is made of a dielectric multilayer film, it is possible to increase the reflection efficiency of the first light L1 incident on the insulating section 48. In the present embodiment, the insulating section 48 is made of aluminum oxide. The insulating section 48 of the present embodiment is formed by performing alumite treatment on the support member 41.

In the embodiment, the insulating section 48 includes a first insulating section 48a and a second insulating section 48c. The first insulating section 48a extends in a direction orthogonal to the incident direction (the Y-axis direction). The first insulating section 48a is provided on the top surface 42. More specifically, the first insulating section 48a is provided in each of a portion on the −Z side of the first top surface 42a and a portion on the +Z side of the second top surface 42b. Thus, the first insulating section 48a is provided at least in the portion of the top surface 42 on the wavelength conversion member 30 side. Therefore, the insulating section 48 is provided on at least a portion of the top surface 42 on the wavelength conversion member 30 side. When viewed from the incident direction, the first insulating section 48a is preferably formed in a wider range than the portion overlapping with the metal wire 37 of the top surface 42. Thus, direct contact between the metal wire 37 and the top surface 42 can be suitably suppressed, so that short-circuiting between the metal wire 37 and the support member 41 can be suppressed.

The second insulating section 48c extends in a direction orthogonal to the Z-axis direction. The second insulating section 48c is connected to the first insulating section 48a. The second insulating section 48c is provided on the side wall surface 44. More specifically, the second insulating section 48c is provided on the first portion 45a of the first side wall surface 45, and the third portion 46a of the second side wall surface 46. Thus, the second insulating section 48c is provided at least in the portion of the side wall surface 44 at the light source section 34 side. Therefore, the insulating section 48 is provided at least on the light source section 34 side of the side wall surface 44. Thus, even if the metal wire 37 enters between the wavelength conversion member 30 and the side wall surface 44, it is possible to suppress the metal wire 37 and the side wall surface 44 from coming into direct contact, thereby suppressing a short circuit between the metal wire 37 and the support member 41. In the present embodiment, the insulating section 48 is provided on each of the first side wall section 41e and the second side wall section 41f. The second insulating section 48c may be provided across the first portion 45a to the second portion 45b, or may be provided across the third portion 46a to the fourth portion 46b.

As described above, the first insulating section 48a is provided on the top surface 42, and the second insulating section 48c is provided on the side wall surface 44. Therefore, in the present embodiment, the insulating section 48 is provided on both the top surface 42 and the side wall surface 44. That is, the insulating section 48 is provided on at least one of the top surface 42 and the side wall surface 44. When viewed from the incident direction (the Y-axis direction), if the metal wire 37 does not overlap the top surface 42, the insulating section 48 may not be provided on the top surface 42. If the metal wire 37 is located on the −Y side with respect to the top surface 42, the insulating section 48 may not be provided on the side wall surface 44. The insulating section 48 may be provided on the entire top surface 42, or may be provided on the entire side wall surface 44.

As described above, in the present embodiment, the metal wire 37 is provided on both the +Z side and the −Z side of the light-emitting element 36. That is, the metal wire 37 is provided on both the first side wall section 41e side and the second side wall section 41f side of the light-emitting element 36. In the present embodiment, the insulating section 48 is provided on both the first side wall section 41e and the second side wall section 41f. Thus, it is possible to suppress a short-circuit between the metal wire 37 and the first side wall section 41e and between the metal wire 37 and the second side wall section 41f by the insulating section 48.

Of the first light L1 emitted from the light-emitting element 36, the first light L11 incident on the space between the wavelength conversion member 30 and the first side wall surface 45 is reflected by the second insulating section 48c and is incident on the fifth surface 30e of the wavelength conversion member 30. Of the first light L1 emitted from the light-emitting element 36, the first light L12 incident on the space between the wavelength conversion member 30 and the first side wall surface 45 is reflected by the second portion 45b and is incident on the fifth surface 30e of the wavelength conversion member 30.

Similarly, of the first light L1 emitted from the light-emitting element 36, the first light L11 incident on the space between the wavelength conversion member 30 and the second side wall surface 46 is reflected by the second insulating section 48c and is incident on the sixth surface 30f of the wavelength conversion member 30. Thus, the amount of the first light L1 that is reflected by the support surface 43 and that returns to the light source section 34 can be reduced, thereby improving the utilization efficiency of the first light L1.

In the present embodiment, each of the first side wall surface 45 and the second side wall surface 46 is a machined surface that has been subjected to mirror finishing. Thus, it is possible to increase the reflectance of the first side wall surface 45 and the second side wall surface 46. Therefore, the first light L1 incident on the first side wall surface 45 and the second side wall surface 46 can be suitably reflected toward the wavelength conversion member 30, thereby improving the utilization efficiency of the first light L1.

According to the present embodiment, the light source device 21 includes the light source section 34, which includes the light-emitting element 36 that emits first light L1 from the light-emitting surface 36a, the substrate 35 that supports the light-emitting element 36, and, at the light-emitting surface 36a side of the light-emitting element 36, the metal wire 37 that electrically connects the light-emitting element 36 and the substrate 35, the wavelength conversion member 30, that is, the light guide member, that receives the first light L1 emitted from the light-emitting element 36 and that emits second light L2, that is, light, and the support member 41 that supports the wavelength conversion member 30 and that has conductivity. The support member 41 includes a support groove 41a for housing accommodating the wavelength conversion member 30, the support groove 41a includes a support surface 43 for supporting the wavelength conversion member 30, and a side wall surface 44 of the side wall section 41c that intersects the support surface 43 and that faces the side surfaces 30e, 30f of the wavelength conversion member 30, the light source section 34 faces the top surface 42 of the side wall section 41c, and an insulating section 48 is provided on at least one of the top surface 42 and the side wall surface 44.

Unlike the present embodiment, in a light source device in which the light source section 34 includes a sealing section that seals each of the light-emitting element 36 and the metal wire 37, and the sealing section suppresses the metal wire 37 and the support member 41 from being short-circuited, it is necessary to position the light-emitting element 36 at least at a distance from the wavelength conversion member 30 corresponding to the thickness of the sealing section. Therefore, in such a light source device, the distance between the light-emitting surface 36a of the light-emitting element 36 and the wavelength conversion member 30 tends to be large in the incident direction (Y-axis direction). Therefore, since the amount of the first light L1 that is not incident on the wavelength conversion member 30 among the first light L1 emitted from the light-emitting element 36 increases, it is difficult to increase the utilization efficiency of the first light L1.

In contrast, in the present embodiment, an insulating section 48 having insulating properties is provided on at least one of the top surface 42 facing the light source section 34 and the side wall surface 44 facing the side surfaces 30e and 30f of the wavelength conversion member 30. Therefore, even if the light source section 34 is disposed close to the wavelength conversion member 30, the insulating section 48 can suppress the metal wire 37 and the support member 41 from being in direct contact with each other. Thus, even if the light source section 34 is disposed close to the wavelength conversion member 30, the metal wire 37 and the support member 41 can be suppressed from being short-circuited. Therefore, the light-emitting surface 36a of the light-emitting element 36 can be disposed close to the wavelength conversion member 30 in the incident direction. Thus, it is possible to suitably reduce the amount of the first light L1 that is not incident on the wavelength conversion member 30 of the first light L1 emitted from the light-emitting element 36. Therefore, it is possible to improve the utilization efficiency of the first light L1 emitted from the light-emitting element 36 while suppressing a short-circuit between the metal wire 37 and the support member 41.

As described above, in the configuration in which the light source section 34 has the sealing section for sealing each of the light-emitting element 36 and the metal wire 37, the first light L1 emitted from the light-emitting element 36 passes through the inside of the sealing section. Therefore, there is a possibility that the transmittance of the sealing section is lowered due to photodegradation of the sealing section. Therefore, the utilization efficiency of the first light L1 may be reduced. Since the light-emitting element 36 is covered with the sealing section, the amount of heat radiated from the light-emitting element 36 to the outside is reduced. Thus, if the temperature of the light-emitting element 36 becomes too high, the light-emitting element 36 may deteriorate.

In contrast to these, in the present embodiment, since the insulating section 48 is provided on the support member 41, the light source section 34 does not have the above-described sealing section. Therefore, it is possible to suppress a decrease in the utilization efficiency of the first light L1 due to photodegradation of the sealing portion. Since the light-emitting element 36 is exposed to the outside, it is possible to suppress a decrease in the amount of heat dissipated from the light-emitting element 36 to the outside. Therefore, it is possible to suppress the temperature of the light-emitting element 36 from becoming too high, so that deterioration of the light-emitting element 36 can be suppressed.

According to the present embodiment, the insulating section 48 is provided on at least the wavelength conversion member 30 side of the top surface 42, that is, a portion at the light guide member side. As described above, the light-emitting element 36 is disposed to face the wavelength conversion member 30 in the incident direction (Y-axis direction), and the metal wire 37 is connected to the light-emitting element 36. Therefore, since the insulating section 48 is provided at least on the wavelength conversion member 30 side of the top surface 42, even if the light source section 34 is disposed close to the wavelength conversion member 30, direct contact between the metal wire 37 and the top surface 42 can be suppressed. As a result, short-circuiting between the metal wire 37 and the support member 41 can be suppressed, so that the light-emitting surface 36a of the light-emitting element 36 can be disposed close to the wavelength conversion member 30. Therefore, it is possible to increase in the utilization efficiency of the first light L1 while suitably suppressing a short-circuit between the metal wire 37 and the support member 41.

According to the present embodiment, the support groove 41a extends in the longitudinal direction (X-axis direction), which is the direction in which the wavelength conversion member 30, that is, the light guide member, the width W2 of the support groove 41a is wider than the width W1 of the light-emitting element 36 as viewed from the longitudinal direction, and the insulating section 48 is provided on at least a portion of the side wall surface 44 at the light source section 34 side. As described above, the metal wire 37 is connected to the light-emitting element 36. Therefore, as in the present embodiment, when the width W2 of the support groove 41a is wider than the width W1 of the light-emitting element 36, and the light source section 34 is disposed close to the wavelength conversion member 30, there is a risk that the metal wire 37 may enter between the wavelength conversion member 30 and the side wall surface 44. On the other hand, in the present embodiment, as described above, since the insulating section 48 is provided in at least the portion of the side wall surface 44 on the light source section 34 side, even when the metal wire 37 enters between the wavelength conversion member 30 and the side wall surface 44, direct contact between the metal wire 37 and the side wall surface 44 can be suppressed. As a result, short-circuiting between the metal wire 37 and the support member 41 can be suppressed, so that the light-emitting surface 36a of the light-emitting element 36 can be disposed close to the wavelength conversion member 30. Therefore, it is possible to increase in the utilization efficiency of the first light L1 while suitably suppressing a short-circuit between the metal wire 37 and the support member 41.

According to the present embodiment, the insulating section 48 includes a first insulating section 48a provided at least on the wavelength conversion member 30 side of the top surface 42, that is, on the light guide member side, and a second insulating section 48c provided at least on the light source section 34 side of the side wall surface 44. Thus, even when the light source section 34 is disposed close to the wavelength conversion member 30, the first insulating section 48a can suppress direct contact between the metal wire 37 and the top surface 42. Even if the metal wire 37 enters between the wavelength conversion member 30 and the side wall surface 44, the second insulating section 48c can suppress direct contact between the metal wire 37 and the side wall surface 44. Accordingly, even when the light source section 34 is disposed close to the wavelength conversion member 30, it is possible to more suitably suppress a short-circuit between the metal wire 37 and the support member 41. Therefore, the light-emitting surface 36a of the light-emitting element 36 can be disposed close to the wavelength conversion member 30. Therefore, it is possible to increase the use efficiency of the first light L1 while more suitably suppressing a short-circuit between the metal wire 37 and the support member 41.

According to the present embodiment, the support member 41 is made of metal. Therefore, as compared to a case where the support member 41 is made of, for example, ceramics, the side wall surface 44 can be easily processed into a mirror surface by a processing method such as polishing. This makes it possible to easily increase the reflection efficiency of the first light L12 incident on the space between the wavelength conversion member 30 and the side wall surface 44 toward the side surfaces 30e and 30f of the wavelength conversion member 30 can be easily enhanced. Therefore, it is possible to reduce the amount of the first light L1 reflected by the support surface 43 and returned to the light source section 34, thus it is possible to more suitably increase the utilization efficiency of the first light L1.

In this embodiment, it is possible to enhance the thermal conductivity of the support member 41 compared to when the support member 41 is made of, for example, ceramic. Thus, by increasing the amount of heat radiated from the wavelength conversion member 30 to the outside of the light source device 21 via the support member 41, it is possible to preferably prevent the temperature of the wavelength conversion member 30 from becoming too high. Therefore, an increase in temperature quenching of the second light L2 in the wavelength conversion member 30 can be suppressed, and the wavelength conversion efficiency of the wavelength conversion member 30 can be improved.

According to this embodiment, the support member 41 is made of aluminum, and the insulating section 48 is made of aluminum oxide. Therefore, by performing the alumite treatment on the support member 41, the insulating section 48 can be provided on the support member 41. Therefore, since the insulating section 48 can be easily provided on the support member 41, it is possible to suppress an increase in manufacturing man-hours and the manufacturing cost of the support member 41.

In the present embodiment, it is preferable that the first insulating section 48a is made of aluminum oxide having black color, which is formed by using an electrolytic solution containing a black dye, a pigment, or the like when performing an alumite treatment. Thus, since the first light L1 incident on the first insulating section 48a can be absorbed, the amount of the first light L1 reflected by the first insulating section 48a and incident on the light source section 34 can be reduced. Therefore, deterioration of the light source section 34 can be suppressed. It is preferable that the second insulating section 48c is made of aluminum oxide having white color, which is formed by using an electrolytic solution containing no black dye, pigment, or the like when performing an alumite treatment. Thus, it is possible to increase the reflection efficiency for reflecting the first light L11 incident on the second insulating section 48c toward the side surfaces 30e, 30f of the wavelength conversion member 30. Therefore, it is possible to increase the utilization efficiency of the first light L1.

According to the present embodiment, the light-emitting element 36 emits the first light L1 having the first wavelength band, and the light guide member is the wavelength conversion member 30 that includes the phosphor 33, that converts the first light L1 into the second light L2 having a second wavelength band different from the first wavelength band, and that emits the second light L2. As described above, in the present embodiment, the light-emitting surface 36a of the light-emitting element 36 can be disposed close to the wavelength conversion member 30 while suppressing short-circuiting between the metal wire 37 and the support member 41. Thus, it is possible to suitably reduce the amount of the first light L1 that does not incident on the wavelength conversion member 30 of the first light L1 emitted from the light-emitting element 36, thereby increasing the utilization efficiency of the first light L1 emitted from the light-emitting element 36. Therefore, the amount of the second light L2 emitted from the wavelength conversion member 30 can be increased.

According to the embodiment, the projector 1 includes the light source device 21, the light modulation devices 4R, 4G, and 4B that modulate second light L2 emitted from the light source device 21, and the projection optical device 6 that projects the light modulated by the light modulation devices 4R, 4G, and 4B. As described above, in the present embodiment, since the utilization efficiency of the first light L1 emitted from the light-emitting element 36 can be increased, the light amount of the second light L2 emitted from the wavelength conversion member 30 can be increased. Thus, it is possible to reduce the amount of the first light L1 necessary for emitting the second light L2 of a predetermined amount of light.

Therefore, since it is possible to reduce the amount of the first light L1 emitted by the light-emitting element 36, it is possible to suppress the power consumed by projector 1.

### Second Embodiment

Hereinafter, the projector 201 of the second embodiment will be described.

The basic configuration of projector 201 according to the present embodiment is the same as that of projector 1 according to the first embodiment, and projector 201 according to the present embodiment includes insulating section 248 in which the reflectivity of second insulating section 248c is larger than the reflectivity of first insulating section 248a. In the following description, the same components as those in the projector 1 of the first embodiment described above are denoted by the same reference numerals, and description thereof will be omitted.

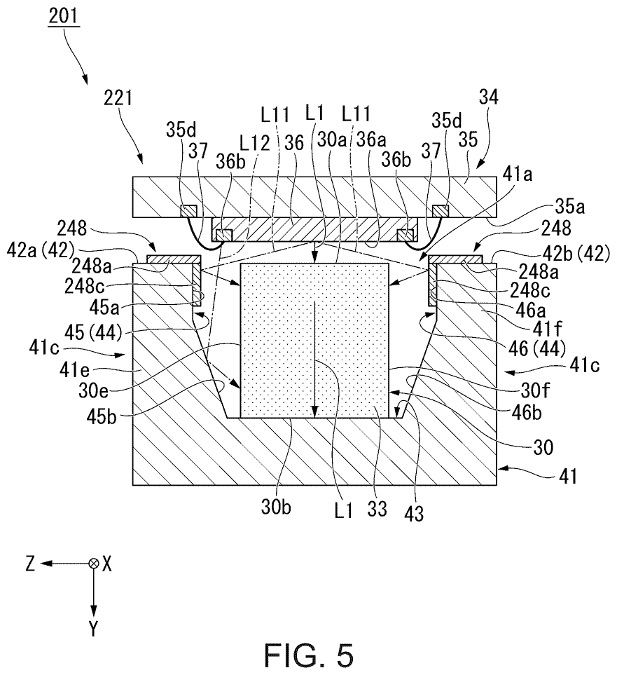

FIG. 5 is a cross-sectional view of the light source device 221 of present embodiment. As shown in FIG. 5, the support member 41 included in the light source device 221 is provided with an insulating section 248. The insulating section 248 includes a first insulating section 248a and a second insulating section 248c.

The first insulating section 248a extends in a direction orthogonal to the incident direction (the Y-axis direction). The first insulating section 248a is provided on a portion of the first top surface 42a on the −Z side and a portion of the second top surface 42b on the +Z side. Thus, the insulating section 248 is provided on at least a portion of the top surface 42 on the wavelength conversion member 30 side. The first insulating section 248a suitably suppresses direct contact between the metal wire 37 and the top surface 42. This makes it possible to suppress the metal wire 37 and support member 41 from short-circuiting. In the present embodiment, the first insulating section 248a is made of ceramics. More specifically, the first insulating section 248a is made of aluminum oxide.

The second insulating section 248c extends in direction orthogonal to the Z-axis direction. The second insulating section 248c is connected to the first insulating section 248a. The second insulating section 248c is provided on the first portion 45a of the first side wall surface 45, and the third portion 46a of the second side wall surface 46. Thus, the insulating section 248 is provided on at least a portion of the side wall surface 44 on the light source section 34 side. Therefore, even if the metal wire 37 enters between the wavelength conversion member 30 and the side wall surface 44, the second insulating section 248c can suppress direct contact between the metal wire 37 and the side wall surface 44. This makes it possible to suppress the metal wire 37 and support member 41 from short-circuiting. In the present embodiment, the second insulating section 248c is configured by a dielectric multilayer film. The reflectance of the second insulating section 248c is larger than the reflectance of the first insulating section 248a. In addition, if the reflectance of the second insulating section 248c can be larger than the reflectance of the first insulating section 248a, the materials configured from the first insulating section 248a and the second insulating section 248c are not limited to this embodiment. The other configurations and the like of light source device 221 of the present embodiment are the same as the other configurations and the like of light source device 21 of the first embodiment described above. The other configurations and the like of projector 201 of the present embodiment are the same as the other configurations and the like of projector 1 of the first embodiment described above.

According to the present embodiment, the reflectance of the second insulating section 248c is larger than the reflectance of the first insulating section 248a. Therefore, since it is possible to increase the reflectance of the second insulating section 248c, among the first light L1 emitted from the light-emitting element 36, the first light L11 that is incident on the space between the wavelength conversion member 30 and the first side wall surface 45 and incidents the second insulating section 48c can be suitably reflected toward the side surfaces 30e, 30f of the wavelength conversion member 30, thereby enhancing the reflection efficiency. Therefore, it is possible to increase the utilization efficiency of the first light L1. In present embodiment, it is easy to suppress an increase in the reflectance of the first insulating section 248a. Therefore, since the first light L1 incident on the first insulating section 248a passes through the first insulating section 248a and easily reaches the top surface 42, the first light L1 is easily absorbed by the support member 41. Thus, the amount of the first light L1 that is reflected by the first insulating section 48a and is incident on the light source section 34 can be reduced, and therefore, deterioration of the light source section 34 can be suppressed. Therefore, the durability of the light source section 34 can be enhanced.

According to the present embodiment, the second insulating section 248c is configured from a dielectric multilayer film. Therefore, the reflectance of the second insulating section 248c can be increased as compared with the case where the second insulating section 248c is made of aluminum oxide, resin, or the like. Thus, of the first light L1 emitted from the light-emitting element 36, the reflection efficiency of reflecting the first light L11 incident on the second insulating section 248c toward the side surfaces 30e, 30f of the wavelength conversion member 30 can be more suitably increased. Therefore, the utilization efficiency of the first light L1 can be more suitably increased.

In the present embodiment, an insulating section 248 is provided on at least one of the top surface 42 and the side wall surface 44. Therefore, as in the first embodiment described above, even when the light source section 34 is disposed close to the wavelength conversion member 30, direct contact between the metal wire 37 and the support member 41 can be suppressed. As a result, short-circuiting between the metal wire 37 and the support member 41 can be suppressed, so that the light-emitting surface 36a of the light-emitting element 36 can be disposed close to the wavelength conversion member 30. Therefore, it is possible to increase in the utilization efficiency of the first light L1 while suitably suppressing a short-circuit between the metal wire 37 and the support member 41.

### Third Embodiment

Hereinafter, the projector 301 of the third embodiment will be described.

The basic configuration of projector 301 according to the present embodiment is the same as that of projector 1 according to the first embodiment, and in projector 301 according to the present embodiment, insulating section 348 is provided on the first side wall section 41e and is not provided on the second side wall section 341f. In the following description, the same components as those in the projector 1 of the first embodiment described above are denoted by the same reference numerals, and description thereof will be omitted.

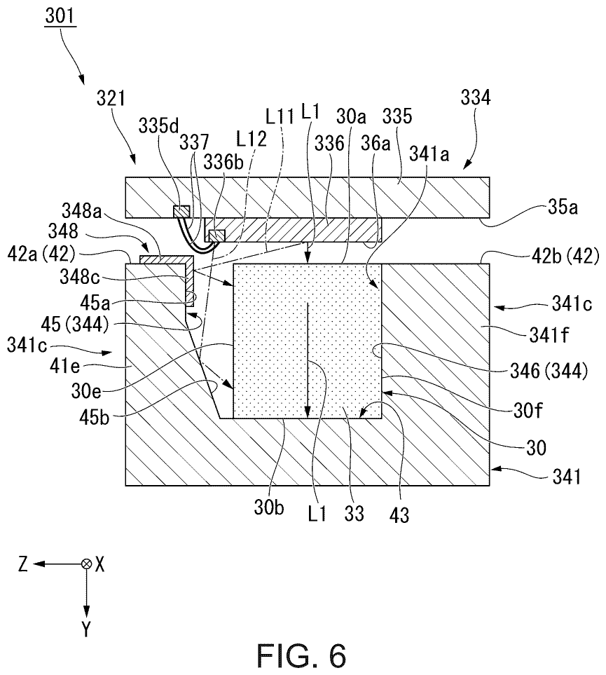

FIG. 6 is a cross-sectional view of the light source device 321 of present embodiment. As shown in FIG. 6, the light source device 321 includes a wavelength conversion member 30, a light source section 334, an angle conversion member 38 (not shown), a mirror 40 (not shown), a support member 341, and a pressing member 49 (not shown). The light source section 334 includes a substrate 335, a light-emitting element 336, and a metal wire 337.

The substrate 335 is a plate-like shape extending in a direction perpendicular to the incident direction (Y-axis direction). A first conductive section 335d electrically connected to the anode electrode 336b of each light-emitting element 336 is provided on the surface 35a of the substrate 335. In the present embodiment, the first conductive section 335d is provided on the +Z side of the light-emitting element 336. That is, the first conductive section 335d is provided on the first side wall section 41e side of the light-emitting element 336, and is not provided on the second side wall section 341f side of the light-emitting element 336. The other configurations and the like of substrate 335 of the present embodiment are the same as the other configurations and the like of substrate 35 of the first embodiment described above.

The light-emitting element 336 is mounted on the surface 35a of the substrate 335. The light-emitting element 336 has an anode electrode 336b and a cathode electrode 36c (not shown). In the present embodiment, the anode electrode 336b is provided on the +Z side portion of the surface of the light-emitting element 336 facing the +Y side. That is, the anode electrode 336b are provided in portions of the light emitting element 336 on the first side wall section 41e side. Other configurations and the like of the light-emitting element 336 of the embodiment are the same as the other configurations and the like of the light-emitting element 36 of the first embodiment described above.

The metal wire 337 electrically connects the anode electrode 336b and the first conductive section 335d. In the present embodiment, when electrically connecting the anode electrode 336b and the first conductive section 335d, a plurality of metal wires 337 can be used. In the present embodiment, the anode electrode 336b and the first conductive section 335d are electrically connected by the two metal wires 337. The number of metal wires 337 electrically connecting the anode electrode 336b and the first conductive section 335d may be three or more. In the present embodiment, since the current is supplied to the light-emitting surface 36a of each light-emitting element 336 via the plurality of metal wires 37, it is possible to stabilize the current density supplied to the light-emitting surface 36a. Thus, the first light L1 can be uniformly emitted from the light-emitting surface 36a. Therefore, each light emitting element 336 can emit uniform and bright first light L1 from the light-emitting surface 36a.

As described above, the anode electrode 336b is provided on the surface facing the +Y side of the light emitting element 336, and the first conductive section 335d is provided on the surface 35a of the substrate 335. Therefore, the metal wire 337 electrically connects the light emitting element 336 and the substrate 335 on the light-emitting surface 36a side of the light emitting element 336. As described above, the anode electrode 336b is provided on the first side wall section 41e side of the light-emitting element 336, and the first conductive section 335d is provided on the first side wall section 41e side of the light-emitting element 336. Therefore, the metal wire 337 is provided on the first side wall section 41e side of the light-emitting element 336, and is not provided on the second side wall section 341f side of the light-emitting element 336. The other configurations and the like of metal wire 337 of the present embodiment are the same as the other configurations and the like of metal wire 37 of the first embodiment described above. The other configurations and the like of light source section 334 of the present embodiment are the same as the other configurations and the like of light source section 34 of the first embodiment described above.

The support member 341 includes a U-shaped configuration when viewed from the longitudinal direction (X-axis direction). The support member 341 includes a support groove 341a and a side wall section 341c. The support groove 341a includes a side wall surface 344. The support groove 341a is configured by a support surface 43 and a side wall surface 344.

The side wall section 341c is a portion of the support member 341 that faces the wavelength conversion member 30 in the Z-axis direction. In the present embodiment, the support member 341 includes two side wall sections 341c. Two side wall sections 341c include a first side wall section 41e and a second side wall section 341f.

The second side wall section 341f is a portion of the support member 341 located on the −Z side of the support groove 341a. The second side wall section 341f faces the sixth surface 30f of the wavelength conversion member 30 in the Z direction. The second side wall section 341f faces the first side wall section 41e in the Z-axis direction with the wavelength conversion member 30 interposed therebetween.

The side wall surface 344 is a surface of the inner surface of the support groove 341a that faces the wavelength conversion member 30 in the Z-axis direction. In present embodiment, the support groove 341a includes two side wall surfaces 344. Two side wall surfaces 344 include first side wall surface 45 and second side wall surface 346.

The second side wall surface 346 is a surface facing the +Z side among the outer surfaces of the second side wall section 341f. The second side wall surface 346 faces the first side wall surface 45 in the Z-axis direction with the wavelength conversion member 30 interposed therebetween. The second side wall surface 346 intersects the support surface 43. The second side wall surface 346 extends in a direction perpendicular to the support surface 43. The second side wall surface 346 is in contact with the other side wall surface 30f of the wavelength conversion member 30 in the Z-axis direction. Therefore, in light source device 321 of the present embodiment, the contact area between wavelength conversion member 30 and support member 341 can be increased as compared with light source device 21 of the first embodiment described above. Thus, the amount of heat transferred from the wavelength conversion member 30 to the support member 341 can be more suitably increased. Therefore, the amount of heat radiated from the wavelength conversion member 30 to the outside of the light source device 321 through the support member 341 can be more suitably increased. Therefore, it is possible to more suitably suppress the temperature of the wavelength conversion member 30 from becoming too high. The other configurations and the like of support member 341 of the present embodiment are the same as the other configurations and the like of support member 41 of the first embodiment described above.

The support member 341 is provided with an insulating section 348. The insulating section 348 suppresses direct contact between the metal wire 337 and the support member 341. In the present embodiment, the insulating section 348 is made of aluminum oxide. The insulating section 348 of the present embodiment is formed by performing alumite treatment on the support member 341.

In the present embodiment, the insulating section 348 is provided on the first side wall section 41e, and is not provided on the second side wall section 341f. The insulating section 348 includes a first insulating section 348a and a second insulating section 348c. The first insulating section 348a is provided in a portion on the −Z side of the first top surface 42a. The second insulating section 348c is connected to the first insulating section 348a. The second insulating section 348c is provided on the first portion 45a of the first side wall surface 45. As described above, in the present embodiment, the metal wire 337 is provided on the first side wall section 41e side of the light emitting element 336, and is not provided on the second side wall section 341f side of the light emitting element 336. Therefore, even when the insulating section 348 is not provided on the second side wall section 341f, direct contact between the metal wire 337 and the second side wall section 341f can be suppressed. The other configurations and the like of light source device 321 of the present embodiment are the same as the other configurations and the like of light source device 21 of the first embodiment described above. The other configurations and the like of projector 301 according to the present embodiment are the same as the other configurations and the like of projector 1 according to the first embodiment described above.

According to this embodiment, the support member 341 includes a plurality of side wall sections 341c, which include a first side wall section 41e facing the wavelength conversion member 30, that is, one side surface 30e of the light guide member, and a second side wall section 341f facing the first side wall section 41e across the wavelength conversion member 30, the metal wire 337 is provided on the side of the light-emitting element 336 adjacent to the first side wall section 41e, but not on the side of the light-emitting element 336 adjacent to the second side wall section 341f, the insulating section 348 is provided on the first side wall section 41e, but not on the second side wall section 341f. Therefore, since the insulating section 348 is provided only on the first side wall section 41e located on the side where the metal wire 337 is provided, it is possible to suppress an increase in the work man-hours for forming the insulating section 348 to the support member 341. Therefore, it is possible to increase the utilization efficiency of the first light L1 while suppressing a short-circuit between the metal wire 337 and the support member 341, and to suppress an increase in the manufacturing cost of the light source device 321.

In the present embodiment, since the second side wall section 341f is not provided with the insulating section 348, the surface area of the portion of the support member 341 covered with the insulating section 348 can be narrowed. Therefore, the amount of heat radiated from the wavelength conversion member 30 to the outside of the light source device 321 through the support member 341 can be increased. Thus, it is possible to suitably suppress the temperature of the wavelength conversion member 30 from becoming too high. Therefore, an increase in temperature quenching of the second light L2 in the wavelength conversion member 30 can be suppressed, and the wavelength conversion efficiency of the wavelength conversion member 30 can be improved.

### Fourth Embodiment

Hereinafter, the projector 401 of the fourth embodiment will be described.

The basic configuration of projector 401 in this embodiment is the same as that of projector 1 in the first embodiment, and in projector 401 of this embodiment, insulating portion 448 is mounted on the mounting surface 447 of support member 441. In the following description, the same components as those in the projector 1 of the first embodiment described above are denoted by the same reference numerals, and description thereof will be omitted.

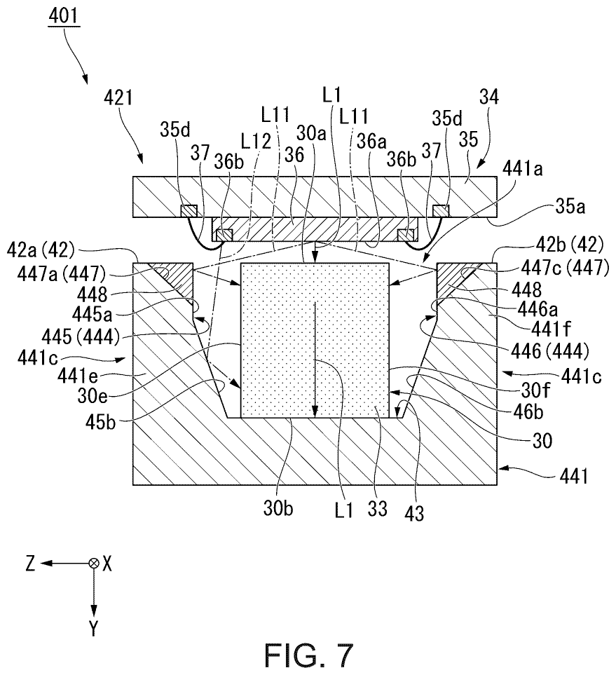

FIG. 7 is a cross-sectional view of the light source device 421 of the present embodiment. As shown in FIG. 7, the light source device 421 includes the wavelength conversion member 30, the light source section 34, the angle conversion member 38 (not shown), the mirror 40 (not shown), the support member 441, the pressing member 49 (not shown), and the insulating section 448.

The support member 441 of the present embodiment includes a U-shaped configuration when viewed from the longitudinal direction (X-axis direction). The support member 441 includes a support groove 441a, a side wall section 441c, and a mounting surface 447. The support groove 441a includes a side wall surface 444. In the present embodiment, the support groove 441a is configured by the support surface 43, the side wall surface 444, and the mounting surface 447.

The side wall section 441c is a part of the support member 441 that faces the wavelength conversion member 30 in the Z-axis direction. The support member 441 includes two side wall sections 441c. Two side wall sections 441c include a first side wall section 441e and a second side wall section 441f.

The first side wall section 441e is a portion of the support member 441 located on the +Z side with respect to the support groove 441a. The first side wall section 441e is opposed to one side surface 30e of the wavelength conversion member 30. The second side wall section 441f is a portion of the support member 441 located on the −Z side with respect to the support groove 441a. The second side wall section 441f is opposed to the other side surface 30f of the wavelength conversion member 30. The second side wall section 441f faces the first side wall section 441e in the Z-axis direction with the wavelength conversion member 30 interposed therebetween.

The side wall surface 444 is a surface of the inner surface of the support groove 441a that faces the wavelength conversion member 30 in the Z-axis direction. The side wall surface 444 intersects the support surface 43. In present embodiment, the support groove 441a includes two side wall surfaces 444. Two side wall surfaces 444 include a first side wall surface 445 and a second side wall surface 446.

The first side wall surface 445 is a surface facing the −Z side among the outer surface of the first side wall section 441e. The first side wall surface 445 is opposed to one side surface 30e of the wavelength conversion member 30. The first side wall surface 445 includes a first portion 445a located on the side farther from the support surface 43, and a second portion 45b located on the side closer to the support surface 43. The first portion 445a extends in a direction perpendicular to the support surface 43. In the present embodiment, the end portion on the −Y side of the first portion 445a is located on the +Y side with respect to the first top surface 42a.

The second side wall surface 446 is a surface facing the +Z side among the outer surfaces of the second side wall section 441f. The second side wall surface 446 is opposed to the other side surface 30f of the wavelength conversion member 30. As described above, the first side wall surface 445 faces one side surface 30e of the wavelength conversion member 30. Therefore, side wall surface 444 faces the side surfaces 30e and 30f of the wavelength conversion member 30. The second side wall surface 446 has a third portion 446a located on the side farther from the support surface 43, and a fourth portion 46b located on the side closer to the support surface 43. The third portion 446a extends in a direction perpendicular to the support surface 43. In the embodiment, the end portion of the third portion 446a on the −Y side is located on the +Y side with respect to the second top surface 42b.

The mounting surface 447 is an inclined surface that connects the side wall surface 444 and the top surface 42. In this embodiment, the support member 441 includes two mounting surfaces 447. Two mounting surfaces 447 include a first mounting surface 447a and a second mounting surface 447c.

The first mounting surface 447a is a part of the outer surface of the first side wall section 441e. The first mounting surface 447a connects an end portion of the first portion 445a on the −Y side and an end portion of the first top surface 42a on the −Z side. Thus, the first mounting surface 447a connects the first side wall surface 445 and the first top surface 42a. When viewed from the longitudinal direction (X-axis direction), the first mounting surface 447a is an inclined surface that becomes more distant from the wavelength conversion member 30 toward the light source section 34 side. The first mounting surface 447a faces a direction inclined from the −Z side to the −Y side.

The second mounting surface 447c is a part of the outer surface of the second side wall section 441f. The second mounting surface 447c connects an end portion of the third portion 446a on the −Y side and an end portion of the second top surface 42b on the +Z side. Thus, the second mounting surface 447c connects the second side wall surface 446 and the second top surface 42b. As described above, the first mounting surface 447a connects the first side wall surface 445 and the first top surface 42a. Thus, the mounting surface 447 connects the side wall surface 444 and the top surface 42. When viewed from the longitudinal direction (X-axis direction), the second mounting surface 447c is an inclined surface that becomes more distant from the wavelength conversion member 30 toward the light source section 34 side. The second mounting surface 447c faces a direction inclined from the +Z side to the −Y side. As described above, the first mounting surface 447a is an inclined surface that becomes more distant from the wavelength conversion member 30 toward the light source section 34 side. Thus, the mounting surface 447 is an inclined surface that becomes more distant from the wavelength conversion member 30, that is, the light guide member, toward the light source section 34 side. When viewed from the incident direction (Y-axis direction), the mounting surface 447 is preferably overlapped with the metal wire 37. The other configurations and the like of support member 441 in the present embodiment are the same as the other configurations and the like of support member 41 in the first embodiment described above.

The insulating section 448 suppresses direct contact between the metal wire 37 and the support member 441. The insulating section 448 has an insulating property. Thus, the insulating section 448 suppresses the metal wire 37 and the support member 441 from being short-circuited. In the present embodiment, the insulating section 448 is substantially triangular prism shape extending in the longitudinal direction (X-axis direction). When viewed from the longitudinal direction (X-axis direction), the insulating section 448 has a right-angled triangle shape with a hypotenuse facing the mounting surface 447. As a material composed of the insulating section 448, for example, glass (silicon dioxide), ceramics such as aluminum oxide, and resin such as polyimide can be used. In the present embodiment, the insulating section 448 is made of polyimide. In the present embodiment, the light source device 421 includes two insulating sections 448.

When viewed from the longitudinal direction (X-axis direction), the oblique side of one insulating section 448 faces the first mounting surface 447a. One insulating section 448 is attached to the first mounting surface 447a. When viewed from the longitudinal direction, the oblique side of the other insulating section 448 faces the second mounting surface 447c. The other insulating section 448 is attached to the second mounting surface 447c. Thus, the insulating section 448 is attached to the mounting surface 447. Each insulating section 448 may be bonded and fixed to the mounting surface 447 by an adhesive (not shown) or may be fixed to the mounting surface 447 by a fastening member such as a screw. Other configurations and the like of light source device 421 of the present embodiment are the same as the other configurations and the like of light source device 21 of the first embodiment described above. The other configurations and the like of projector 401 according to the present embodiment are the same as the other configurations and the like of projector 1 according to the first embodiment described above.

According to the present embodiment, the support member 441 includes the wavelength conversion member 30, that is, the support groove 441a accommodating the light guide member, and the mounting surface 447. The support groove 441a includes a support surface 43 that supports the wavelength conversion member 30, and the side wall surface 444 of the side wall section 441c intersects the support surface 43 and faces the side surfaces 30e and 30f of the wavelength conversion member 30, the light source section 34 is opposite the top surface 42 of the side wall section 441c, the mounting surface 447 is an inclined surface that connects the side wall surface 444 and the top surface 42 and, as it moves toward the light source section 34 side, it moves away from the wavelength conversion member 30, the insulating section 448 is mounted on the mounting surface 447. Therefore, even if the light source section 34 is disposed close to the wavelength conversion member 30, the insulating section 448 can suppress the direct contact between the metal wire 37 and the support member 441. Thus, even if the light source section 34 is disposed close to the wavelength conversion member 30, it is possible to suppress short-circuiting between the metal wire 37 and the support member 441. Therefore, the light-emitting surface 36a of the light-emitting element 36 can be disposed close to the wavelength conversion member 30 in the incident direction (Y-axis direction). Therefore, it is possible to increase the utilization efficiency of the first light L1 emitted from the light-emitting element 36 while suppressing a short-circuit between the metal wire 37 and the support member 441.

In the present embodiment, the insulating section 448 and the support member 441 are separate members. Therefore, the insulating portion 448 can be disposed between the support member 441 and the metal wire 37 by a simple operation of attaching the insulating portion 448 to the mounting surface 447 after the insulating portion 448 and the support member 441 are separately manufactured. Therefore, for example, compared to a case where the insulating section 448 is formed on the surface of the support member 441 by physical vapor deposition or the like, it is easy to suppress an increase in the number of manufacturing man-hours of the light source device 421.

Although the embodiments of the present disclosure have been described d above, the technical scope of the present disclosure is not limited to the above-described embodiments, and various modifications can be made without departing from the spirit of the present disclosure. One aspect of the present disclosure may be configured by appropriately combining the characteristic portions of the above-described embodiments.

In the above-mentioned embodiment, an example of applying the present disclosure to a light source device including a wavelength conversion member is provided. However, instead of this configuration, the present disclosure may also be applied to a light source device in which incident light is propagated without performing wavelength conversion, and then the incident light is emitted by controlling, for example, an angular distribution. In this case, the wavelength conversion member in the above-mentioned embodiment replaces the light guide member, and the light emitted from the light-emitting element is emitted to the angle conversion member as light of the same wavelength band.

Furthermore, the specific descriptions of the shape, number, arrangement, material, and other aspects of each component of the light source device and the projector are not limited to the above-mentioned embodiment and can be suitably modified. In the above-mentioned embodiment, the example is shown in which the light source device according to the present disclosure is mounted on the projector using the liquid crystal panel has been described, but the invention is not limited to this. The light source device according to the present disclosure may be applied to a projector using a digital micromirror device as a light modulation device. The projector may not include multiple light modulation devices and may include only one light modulation device.

In the above-mentioned embodiment, the example is shown in which the light source device according to the present disclosure is applied to a projector, but the present invention is not limited to this. The light source device of the present disclosure can also be applied to lighting fixtures, automobile headlights, or the like.

### Summary of Present Disclosure

Hereinafter, a summary of the present disclosure is appended.

### Appendix 1

A light source device including a light source section including a light-emitting element that emits light from a light-emitting surface, a substrate that supports the light-emitting element, and, at a light-emitting surface side of the light-emitting element, a metal wire that electrically connects the light-emitting element and the substrate, a light guide member into which the light emitted from the light-emitting element enters and from which the light is emitted, and a support member that supports the light guide member and that has conductivity, wherein the support member includes a support groove for accommodating the light guide member, the support groove includes

a support surface that supports the light guide member and a side wall surface of a side wall section that intersects with the support surface and that faces a side surface of the light guide member, the light source section faces a top surface of the side wall section, and an insulating section is provided on at least one of the top surface and the side wall surface.

According to the light source device of this configuration, it is possible to suppress direct contact between the metal wire and the support member by the insulating section. Therefore, the light-emitting surface of the light-emitting element can be disposed close to the wavelength conversion member in the incident direction. Therefore, it is possible to increase the utilization efficiency of the first light emitted from the light-emitting element while suppressing a short-circuit between the metal wire and the support member.

### Appendix 2

The light source device according to Appendix 1, wherein the insulating section is provided on at least a portion of the top surface at a light guide member side.

According to this configuration, direct contact between the metal wire and the top surface can be suppressed by the insulating section. Thus, short-circuiting between the metal wire and the support member can be suppressed, allowing the light-emitting surface of the light-emitting element to be disposed close to the wavelength conversion member. Therefore, it is possible to increase the utilization efficiency of the first light while suitably suppressing a short-circuit between the metal wire and the support member.

### Appendix 3

The light source device according to Appendix 1 or 2, wherein the support groove extends in a longitudinal direction, which is a direction in which the light guide member extends, when viewed from the longitudinal direction, a width of the support groove is wider than a width of the light-emitting element, and the insulating section is provided on at least a portion of the side wall surface at a light source section side.

According to this configuration, direct contact between the metal wire and the side wall surface can be suppressed by the insulating section. Thus, short-circuiting between the metal wire and the support member can be suppressed, allowing the light-emitting surface of the light-emitting element to be disposed close to the wavelength conversion member. Therefore, it is possible to increase the utilization efficiency of the first light while suitably suppressing a short-circuit between the metal wire and the support member.

### Appendix 4

The light Source device according to Appendix 1, wherein the insulating section has a first insulating section provided on at least a portion of the top surface at a light guide member side and a second insulating section provided on at least a portion of the side wall surface at a light source section side.

According to this configuration, direct contact between the metal wire and the top surface can be suppressed by the first insulating section, and direct contact between the metal wire and the side wall surface can be suppressed by the second insulating section. Thus, the short-circuit between the metal wire and the support member can be more suitably suppressed, so that the light-emitting surface of the light-emitting element can be disposed close to the wavelength conversion member. Therefore, it is possible to increase the utilization efficiency of the first light while more suitably suppressing a short-circuit between the metal wire and the support member.

### Appendix 5

The light source device according to Appendix 4, wherein a reflectance of the second insulating section is larger than a reflectance of the first insulating section.

According to this configuration, it is possible to suitably increase the reflection efficiency of reflecting the first light incident on the second insulating section toward the side surface of the wavelength conversion member. Therefore, the utilization efficiency of the first light can be increased.

### Appendix 6

The light source device according to Appendix 4 or 5, wherein the second insulating section is configured by a dielectric multilayer film.

According to this configuration, it is possible to more suitably increase the reflection efficiency of reflecting the first light incident on the second insulating section toward the side surface of the wavelength conversion member. Therefore, the utilization efficiency of the first light L1 can be more suitably increased.

### Appendix 7

The light source device according to any one of Appendixes 1 to 6, further including the support member includes a plurality of side wall sections, the plurality of the side wall sections include a first side wall section facing one side surface of the light guide member, and a second side wall section facing the first side wall section with the light guide member interposed therebetween, the metal wire is provided on a first side wall section side of the light-emitting element and is not provided on a second side wall section side of the light-emitting element, and the insulating section is provided on the first side wall section and is not provided on the second side wall section.

According to this configuration, the insulating section is provided only on the first side wall section located on the side where the metal wire is provided, it is possible to suppress an increase in the work man-hours for forming the insulating section to the support member.

### Appendix 8

A light source device including a light source section including a light-emitting element that emits light from a light-emitting surface, a substrate that supports the light-emitting element, and, at a light-emitting surface side of the light-emitting element, a metal wire that electrically connects the light-emitting element and the substrate, a light guide member into which the light emitted from the light-emitting element enters and from which the light is emitted; and a support member that supports the light guide member and that has conductivity, wherein the support member includes a support groove for accommodating the light guide member, and a mounting surface, the support groove includes a support surface that supports the light guide member and a side wall surface of a side wall section that intersects with the support surface and that faces a side surface of the light guide member, the light source section faces a top surface of the side wall section, the mounting surface connects the side wall surface and the top surface, and the insulating section is attached to the mounting surface.

According to this configuration, direct contact between the metal wire and the support member can be suppressed by the insulating section. Therefore, the light-emitting surface of the light-emitting element can be disposed close to the wavelength conversion member in the incident direction. Therefore, it is possible to increase the utilization efficiency of the first light emitted from the light-emitting element while suppressing a short-circuit between the metal wire and the support member.

### Appendix 9

The light source device according to any one of Appendixes 1 to 8, wherein the support member is made of metal.

According to this configuration, the side wall surface can be easily processed into a mirror finish by a processing method such as polishing. Thus, the reflection efficiency of reflecting the first light incident on the space between the wavelength conversion member and the side wall surface toward the side surface of the wavelength conversion member can be easily enhanced. Therefore, the utilization efficiency of the first light can be more suitably enhanced.

### Appendix 10

The light source device according to any one of Appendixes 1 to 9, wherein the support member is made of aluminum, and the insulating section is made of aluminum oxide.

According to this configuration, by performing the alumite treatment on the support member, it is possible to provide the insulating section to the support member. Therefore, since the insulating section can be easily provided on the support member, it is possible suppress an increase in manufacturing man-hours and manufacturing cost of the support member.

### Appendix 11

The light source device according to any one of Appendixes 1 to 10, wherein the light-emitting element emits first light having a first wavelength band and the light guide member includes a phosphor, converts the first light into second light with a second wavelength band different from the first wavelength band, and is a wavelength conversion member that emits the second light.

According to this configuration, the light-emitting surface of the light-emitting element can be disposed close to the wavelength conversion member while suppressing a short-circuiting between the metal wire and the support member. Thus, it is possible to increase the utilization efficiency of the first light emitted from the light-emitting element. Therefore, it is possible to increase the amount of second light emitted from the wavelength conversion member.

### Appendix 12

A projector including the light source device according to any one of Appendixes 1 to 11, and a light modulation device that modulates the light emitted from the light source device; and a projection optical device that projects the light modulated by the light modulation device.

According to the projector with this configuration, it is possible to reduce the amount of first light necessary for emitting the second light with the predetermined amount. Therefore, since the amount of the first light emitted by the light-emitting element can be reduced, the electric power consumed by the projector can be suppressed.

What is claimed is:

1. A light source device comprising:
a light source section including a light-emitting element that emits light from a light-emitting surface, a substrate that supports the light-emitting element, and, at a light-emitting surface side of the light-emitting element, a metal wire that electrically connects the light-emitting element and the substrate;
a light guide member into which the light emitted from the light-emitting element enters and from which the light is emitted; and
a support member that supports the light guide member and that has conductivity, wherein
the support member includes a support groove for accommodating the light guide member,
the support groove includes
a support surface that supports the light guide member and
a side wall surface of a side wall section that intersects with the support surface and that faces a side surface of the light guide member,
the light source section faces a top surface of the side wall section, and
an insulating section is provided on at least one of the top surface and the side wall surface.

2. The light source device according to claim 1, wherein
the insulating section is provided on at least a portion of the top surface at a light guide member side.

3. The light source device according to claim 1, wherein
the support groove extends in a longitudinal direction, which is a direction in which the light guide member extends,
when viewed from the longitudinal direction, a width of the support groove is wider than a width of the light-emitting element, and
the insulating section is provided on at least a portion of the side wall surface at a light source section side.

4. The light source device according to claim 1, wherein
the insulating section has a first insulating section provided on at least a portion of the top surface at a light guide member side and a second insulating section provided on at least a portion of the side wall surface at a light source section side.

5. The light source device according to claim 4, wherein
a reflectance of the second insulating section is larger than a reflectance of the first insulating section.

6. The light source device according to claim 4, wherein
the second insulating section is configured by a dielectric multilayer film.

7. The light source device according to claim 1, wherein
the support member includes a plurality of side wall sections,
the plurality of the side wall sections include a first side wall section facing one side surface of the light guide member, and a second side wall section facing the first side wall section with the light guide member interposed therebetween,
the metal wire is provided on a first side wall section side of the light-emitting element and is not provided on a second side wall section side of the light-emitting element, and
the insulating section is provided on the first side wall section and is not provided on the second side wall section.

8. A light source device comprising:
a light source section including a light-emitting element that emits light from a light-emitting surface, a substrate that supports the light-emitting element, and, at a light-emitting surface side of the light-emitting element, a metal wire that electrically connects the light-emitting element and the substrate;
a light guide member into which the light emitted from the light-emitting element enters and from which the light is emitted; and
a support member that supports the light guide member and that has conductivity, wherein
the support member includes a support groove for accommodating the light guide member, and a mounting surface,
the support groove includes
a support surface that supports the light guide member and
a side wall surface of a side wall section that intersects with the support surface and that faces a side surface of the light guide member,
the light source section faces a top surface of the side wall section,
the mounting surface connects the side wall surface and the top surface, and
the insulating section is attached to the mounting surface.

9. The light source device according to claim 1, wherein
the support member is made of metal.

10. The light source device according to claim 1, wherein
the support member is made of aluminum,
the insulating section is made of aluminum oxide.

11. The light source device according to claim 1, wherein
the light-emitting element emits first light having a first wavelength band and
the light guide member includes a phosphor, converts the first light into second light with a second wavelength band different from the first wavelength band, and is a wavelength conversion member that emits the second light.

12. A projector comprising:
the light source device according to claim 1;
a light modulation device that modulates the light emitted from the light source device; and
a projection optical device that projects the light modulated by the light modulation device.
